(19) United States
(12) Patent Application Publication
(10) Pub. No.: US 2018/0308067 A1
(43) Pub. Date: Oct. 25, 2018

(54) ATTENDEE SPECIFIC MEETING ATTRIBUTES

(71) Applicant: Microsoft Technology Licensing, LLC, Redmond, WA (US)

(72) Inventors: Dipak Sarjerao Pawar, Sammamish, WA (US); Jaskaran Singh, Sammamish, WA (US)

(21) Appl. No.: 15/496,360

(22) Filed: Apr. 25, 2017

(51) Int. Cl. G06Q 10/10; H04L 12/58; H04M 3/56

(52) U.S. Cl. CPC G06Q 10/1095; H04M 3/565; G06Q 10/107; H04L 51/20

(57) ABSTRACT

Various embodiments of the present technology generally relate to scheduling meetings. More specifically, some embodiments relate to generating customized meeting invites with attendee specific meeting attributes. Some embodiments provide for an invitation tool (e.g., that may be part of a mailbox server) that can automatically identify attendee preferences, create custom polls to gather attendee information, and easily generate custom invitations. In some embodiments, the invitation tool can generate separate individualized links that provides access to a poll with customized attributes based on local environments of each of the plurality of individuals. The tool can analyze the poll responses and then generate custom invites for each attendee by altering one or more attributes or fields. For example, if one attendee is attending remotely, their invite may be altered to only show the remote conferencing information where as other attendees receive invites with only a physical location.

### BACKGROUND

Successful companies of all sizes need employees to work jointly together and collaborate on various projects, designs, and other endeavors. This is true of intellectually based endeavors as well as physically based endeavors. As part of the collaboration process, employees often collaborate via teleconference, via video chat, in conference rooms or other collaborative space in order to share ideas, share project goals, share project status and otherwise facilitate portions of the collaboration. For very small companies, all of the employees can easily fit within a small space. As companies grow, however, the employees become spread out within multiple locations around the world.

With the employees not physically collocated and more diverse, scheduling meetings becomes more difficult as the meeting requestor may not immediate appreciate additional variables for identifying meeting times and locations. For example, employees may have different working hours (e.g., based on time zone differences), language preferences, and access to meeting rooms. To make matter worse, some employees may be traveling or at different locations during proposed meeting times. As such, for these and other reasons, additional tools are needed to improve the meeting scheduling processes.

Overall, the examples herein of some prior or related systems and their associated limitations are intended to be illustrative and not exclusive. Upon reading the following, other limitations of existing or prior systems will become apparent to those of skill in the art.

### OVERVIEW

Various embodiments of the present technology generally relate to scheduling meetings. More specifically, some embodiments relate to generating customized meeting invites with attendee specific meeting attributes. Some embodiments provide for a system comprising one or more processors and one or more computer readable media. The computer readable media can have an e-mail application stored thereon with program instructions which, when executed by the one or more processors, direct the system to perform a variety of operations. For example, in some embodiments the operations can include receiving a request to poll multiple individuals regarding availability for a meeting.

The operations can also include generating separate individualized links for each of the multiple individuals. In accordance with various, each of the separate individualized links may provide the poll with customized attributes based on corresponding local environment of the multiple individuals. In addition, the instructions can also cause the system to transmit the separate individualized links to the multiple individuals which, for example can provide multiple time and location options that are, at least in part, customized based on the local environment (e.g., working hours, language preference, etc.) of a corresponding individual from the multiple individuals.

The system can receive responses to the poll through the separate individualized links and generate, based on the responses to the poll and the corresponding local environment of the multiple individuals, customized meeting invites to each of the multiple individuals. In some embodiments, the customized meeting invites may be altered, based at least in part on the local environment. These alterations can include alterations to the contents of a subject field, a location field, a note field, or a time field.

In some embodiments, a poll may not be used before sending meeting invitations to the attendees. For example, the organizer may decide not to send a poll or the system may detect that a poll is unavailable or likely to be completed in time. In some of these embodiments, the meeting invitations may include the same data to all attendees. However, depending on when/where/how attendee accesses the invitation the attendees will see different data. As a result, the same attendee can see different data depending on local environment (e.g., location, accessing device, time of retrieval, and the like). As such, the invitation for each attendee maybe a dynamic invitation that can change according to the environment used to access the data. Of course, in some embodiments, customized invitations may be used with or without the polling. In addition, in some embodiments, the customized invitations used with the polling may also dynamic and present data relevant to the local environment or other detected parameter.

Embodiments of the present invention also include computer-readable storage media containing sets of instructions to cause one or more processors to perform the methods, variations of the methods, and other operations described herein.

Some embodiments provide for a method that includes receiving a request to invite multiple individuals to a meeting. In response to the request, characteristics of a local environment of each of the multiple individuals can be identified. Based on the characteristics of the local environment of each of the multiple individuals, a customized invite to the meeting can be generated and sent. In some embodiments, the local environment of each of the multiple individuals can be identified and calendar information can be accessed. A poll can be generated that with customized interfaces for each of the multiple individuals. In some embodiments, each of the customized interfaces may have multiple time and location options based on the local environment and the calendar information of each of the multiple individuals. For example, the poll may include an option for a telephone or video conference when the local environment of at least two of the multiple individuals indicate different locations.

Once the responses are received, meeting invites to each of the multiple individuals can be generated and customized based on the responses from the poll and the local environment of each of the multiple individuals. For example, the customized invite for each of the multiple individuals may alter contents of a subject field, a location field, a note field, a time field or other meeting invitation field.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Embodiments of the present technology will be described and explained through the use of the accompanying drawings in which:

FIG. 1 illustrates an example of an environment with an invitation tool capable of providing invitations with attendee specific meeting attributes in accordance with some embodiments of the present technology;

FIG. 2 illustrates a set of components associated with an invitation tool that may be used in one or more embodiments of the present technology;

FIG. 3 illustrates an example of a set of operations for generating customized meeting invites according to one or more embodiments of the present technology;

FIG. 4 illustrates a set of components that may be used according to one or more embodiments of the present technology;

FIG. 5 illustrates an example of a set of operations for allowing a meeting organizer to find and select times that may work for multiple attendees in accordance with some embodiments of the present technology;

FIG. 6 is a sequence diagram illustrating an example of the data flow between various components according to various embodiments of the present technology; and

FIG. 7 illustrates an example of a computing system, which is representative of any system or collection of systems in which the various applications, services, scenarios, and processes disclosed herein may be implemented.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to scheduling meetings. More specifically, some embodiments relate to generating customized meeting invites with attendee specific meeting attributes. Traditional systems typical send uniform meeting invites to all attendees. As a result, each attendee sees the same meeting attributes like subject, location, description (body), etc. Consequently, when a meeting organizer is sending a meeting invite to a group of attendees that contains people from multiple locations, the invites are all the same. There has traditionally been no easy way to have customized invites each indicating separate meeting locations. As a result, organizers often list multiple locations in the body of the invite or create multiple separate meetings for each group.

In contrast, some embodiments allow for custom generated invites with attendee specific meeting attributes like subject, location, body, language, etc. As a result, the attendees at a first location would receive information about a local conference room for attending the meeting, while attendees at a second location might receive information about their local conference room. Similarly, remote attendees may only receive information about telephone or video conference (e.g., using Skype). Other customization, like language preference, notes from the organizer, etc. may be provided in some embodiments.

Various embodiments of the present technology provide for a wide range of technical effects, advantages, and/or improvements to computing systems and components. For example, various embodiments include one or more of the following technical effects, advantages, and/or improvements: 1) reducing the number of user interactions when generating meeting invites; 2) automatically identifying attendees specific information and customizing polls and/or meeting invites; 3) providing a polling system for identifying best times and locations for meetings; 4) creating improvements to the way computing devices operate; 5) use unconventional and non-routine operations as part of creating and sending polls and/or meeting invites; 6) use of custom links and graphical user interfaces for identifying meeting times and/or other options; and/or 7) changing the manner in which a computing system reacts to a request to setup a meeting (e.g., by polling and/or customized invites). Some embodiments include additional technical effects, advantages, and/or improvements to computing systems and components.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to creating attendee specific meeting invites, embodiments of the present technology are equally applicable to various other types of customized invitations.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

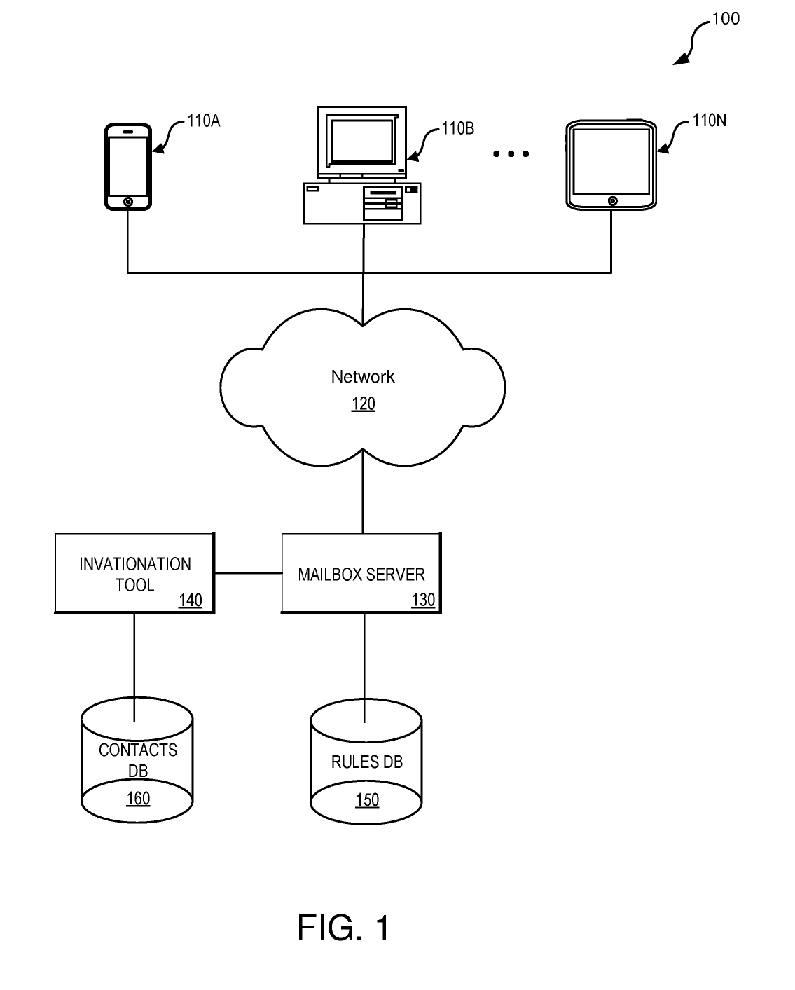

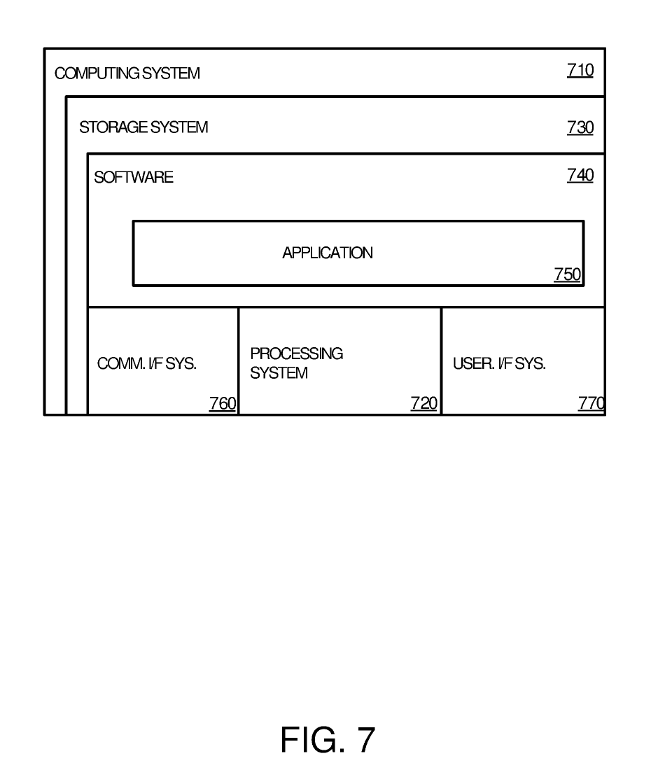

FIG. 1 illustrates an example of an environment with an invitation tool capable of providing invitations with attendee specific meeting attributes in accordance with some embodiments of the present technology. As illustrated in FIG. 1, environment 100 may include one or more computing devices 110A-110N, communications network 120, mailbox servers 130, invitation tool 140, and various databases such as rules database 150 and contacts database 160. Computing devices 110A-110N can be any computing system capable of running an application natively or in the context of a web browser, streaming an application, or executing an application in any other manner Examples of computing devices 110A-110N include, but are not limited to, personal computers, mobile phones, tablet computers, mobile media device, desktop computers, laptop computers, wearable computing devices, or any other form factor, including any combination of computers or variations thereof. Computing devices 110A-110N may include various hardware and software elements in a supporting architecture suitable for providing an e-mail application that can access mailbox servers 130. One such representative architecture of a computing device is illustrated in FIG. 7 with respect to computing system 710.

Those skilled in the art will appreciate that various components (not shown) may be included in computing devices 110A-110N to enable network communication with communication network 120. In some cases, communication network 120 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

Invitation tool 140 can be integrated with, or communicably coupled to mailbox server 130. In accordance with various embodiments, invitation tool 140 can process a meeting invite and generate separate individualized links that each correspond to one of a plurality of individuals identified in the invite. Invitation tool 140 can access contact database 160 to identify local environments for each of the attendees. Invitation tool 140 can generate separate individualized links that provide access to a poll with customized attributes based on local environments of each of the plurality of individuals. The links to the polls can be transmitted to the attendees (e.g., using mailbox server 130). As the responses to the polls are received, a time and date can be set for the meeting and customized meeting invites can be sent to each of the plurality of individuals.

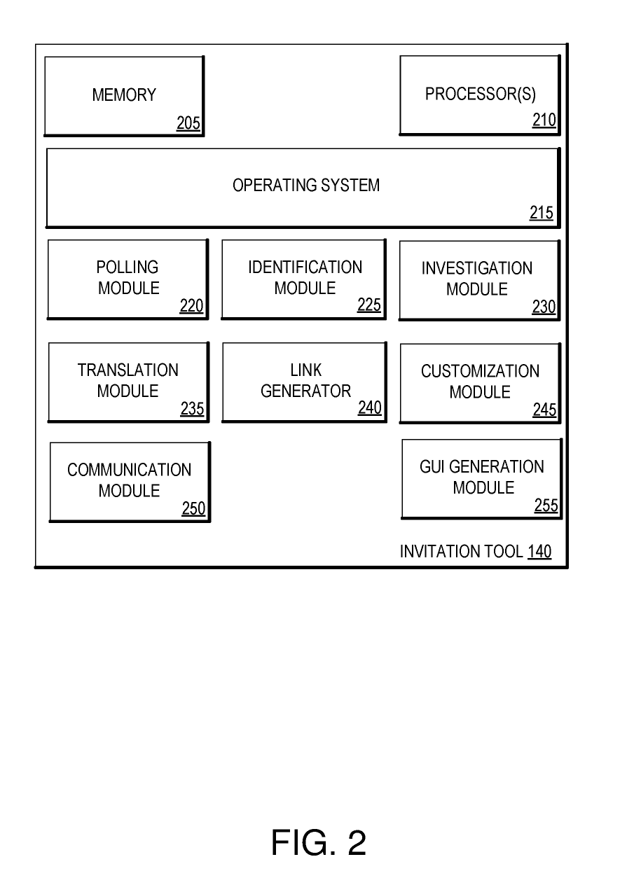

FIG. 2 illustrates a set of components associated with an invitation tool 140 that may be used in one or more embodiments of the present technology. According to the embodiments shown in FIG. 2, invitation tool 140 can include memory 205, one or more processors 210, operating system 215, polling module 220, identification module 225, investigation module 230, translation module 235, link generator 240, customization module 245, communication module 250, and graphical user interface (GUI) generation module 255. Each of these modules can be embodied as special-purpose hardware (e.g., one or more ASICS, PLDs, FPGAs, or the like), or as programmable circuitry (e.g., one or more microprocessors, microcontrollers, or the like) appropriately programmed with software and/or firmware, or as a combination of special purpose hardware and programmable circuitry. Other embodiments of the present technology may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, the functionality of translation module 235 and customization module 245 may be combined into a single module or system. Similarly, some embodiments may include a reservation module (not shown) that can reserve rooms in one or more locations and/or set up remote conferencing information.

Memory 205 can be any device, mechanism, or populated data structure used for storing information. In accordance with some embodiments of the present technology, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of polling module 220, identification module 225, investigation module 230, translation module 235, link generator 240, customization module 245, communication module 250, and/or GUI generation module 255. Operating system 215 can provide a software package that is capable of managing the hardware resources of invitation tool 140. In some embodiments, operating system 215 can also provide common services for software applications running on processor(s) 210.

Polling module 220 can be used to generate polls for identifying the best time and date for a meeting or event. In accordance with various embodiments, the polls can be customized for each attendee. As such, polling module 220 can use identification module 225 to identify the potential attendees and investigation module 230 to retrieve local environment information for each of the attendees. The local environment information may include, but is not limited to, local time zones, nearby conference rooms, language preferences, working hours, and the like. Using this information, polling module 220 can then generate customized polls for each individual attendee.

For example, in some embodiments, investigation module 230 may identify whether the attendees are in different locations, prefer different languages, have different working hours, and the like. If a different language is identified by investigation module 230, then translation module 235 can translate the poll to the preferred language. As such, a polling request and the poll itself may be presented in the preferred language of each recipient. The polling request may be sent via e-mail or other means such as communication module 250. Consequently, if one recipient prefers Russian, while another recipient prefers German, then as each activates a link generated by link generator 240 a poll can be presented in the desired language.

Customization module 245 can analyze the responses from the polls and determine one or more times that work best for the attendees. Customization module 245 can then create custom invites that include various alterations to attributes of the invitations. For example, the invites can be translated (e.g., using translation module 235) into a preferred language identified by the local environment of one of the plurality of individuals. Other examples of attributes that can be customized include, but are not limited to, a subject field, a location field, a notes field, or a time field. For example, if a first attendee is at a first location and a second attendee is at a second location, the location field can be changed in each invite to show only the corresponding location. In some embodiments, the customized invites may provide an indication (e.g., icon, color code, menu option) for selecting one of the other possible attribute options (e.g., language, other locations, etc.). As such, if an invite has a specific location and the user then has to travel, the user may select, or request, another option (e.g., remote conferencing information).

Communication module 250 can be configured to manage and translate any requests from format requirements of one system component into a format required by the destination component and/or system. For example, communications module 250 may be used to communicate between systems and/or modules that use different communication protocols, data formats, or messaging routines.

GUI generation module 255 can generate one or more GUI screens that allow for interaction with a user. In at least one embodiment, GUI generation module 255 can generate a graphical user interface allowing a user to respond to polls, set preferences, review polling results, schedule meetings, review reports, and/or otherwise receive or convey information to the user.

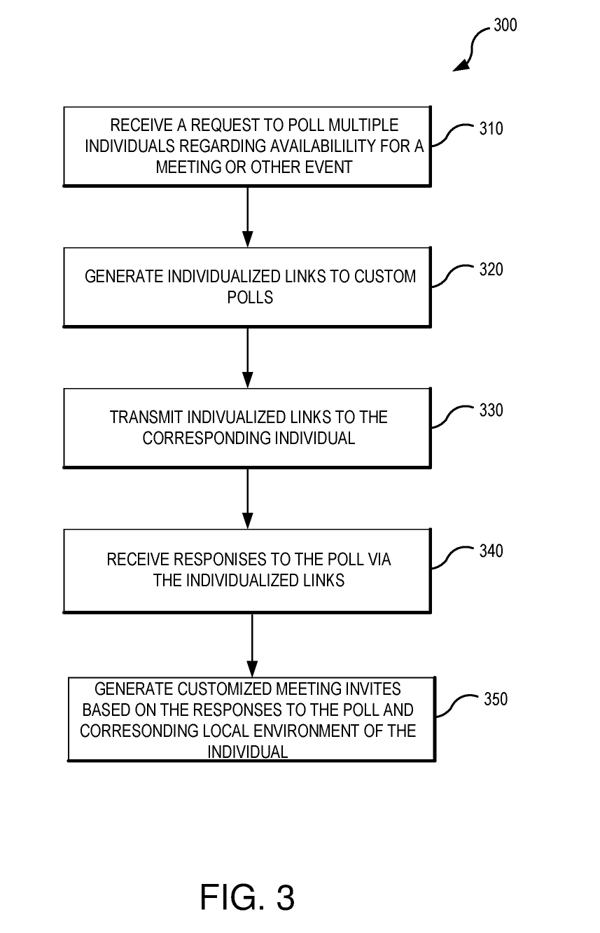

FIG. 3 illustrates an example of a set of operations 300 for generating customized meeting invites according to one or more embodiments of the present technology. These operations may be performed by various systems or components such as, but not limited to, invitation tool 140, processors 210, polling module 220, identification module 225, investigation module 230, translation module 235, link generator 240, customization module 245, communication module 250, GUI generation module 255, and/or other component, computing device, or module.

As illustrated in FIG. 3, receiving operation 310 can receive a request to poll multiple individuals regarding availability for a meeting or other event. Upon receiving the request to poll multiple individuals, generation operation 320 can generate individualized links to custom polls for each of the individuals. These custom polls may automatically translate or adjust various polling attributes based on local environments of the individual. For example, language or time zones can be adjusted. Similarly, if an indication of preferred working hours or a calendar is available, then the poll may be adjusted by eliminating times outside of working hours or where a conflict already exists. In some embodiments, the poll may try to determine one or more preferred time slots (e.g., based on calendar data, historical preferences, and the like). Based on this identification, the poll may be organized to present those time slots first while placing other time slots later in the poll.

Transmission operation 330 can transmit the individualized links to the corresponding individual (e.g., by a custom automated e-mail). When a user activates one of the links, the customized poll can be generated. The responses can be received during response operation 340. Using the response information and local environment information, invitation operation 350 can generated customized meeting invites.

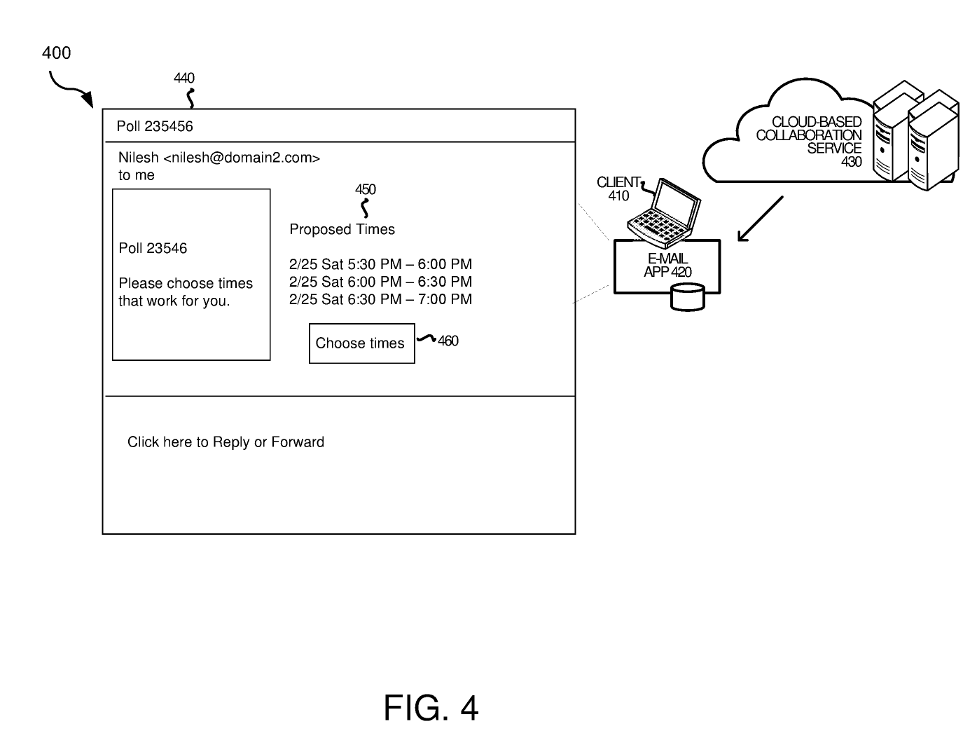

FIG. 4 illustrates a set of components 400 that may be used according to one or more embodiments of the present technology. As illustrated in FIG. 4, client device 410 can run e-mail application 420 (or other application capable of scheduling meetings) that can access attendee information from cloud-based collaboration service 430. The collaboration or content service 430 is representative of any service providing shared access to cloud-based or centralized communication, content, and centralized storage. As shown in the example of FIG. 4, e-mail 440 can be opened on client device 410 with e-mail application 420. The e-mail application 420 can include functionality including GUIs (graphical user interface) running on client device 410, e.g., a PC, mobile phone device, a Web server, or other application servers. Such systems may employ one or more virtual machines, containers, or any other type of virtual computing resource.

E-mail 440 represents an example of a custom poll to identify a collaboration time. The summary of the poll presented in e-mail 440 may be translated from the original language (e.g., Russian) to a language of the receiver (e.g., English). Similarly, the proposed time may be presented in the local time zones. As another example, the proposed times 450 maybe adjusted based on working hours of the recipient, existing meeting conflicts, and/or other available data that may be indicative of the recipient being unavailable. The recipient can click on link 460 to select one or more preferred times. In some embodiments, the poll may allow the recipient to select and/or rank multiple times. In addition, the poll may collect other information such as personalized notes from the organizer or location of the individual that can be used to setup a meeting room or remote access (e.g., dial-in, video chat, or bridge information).

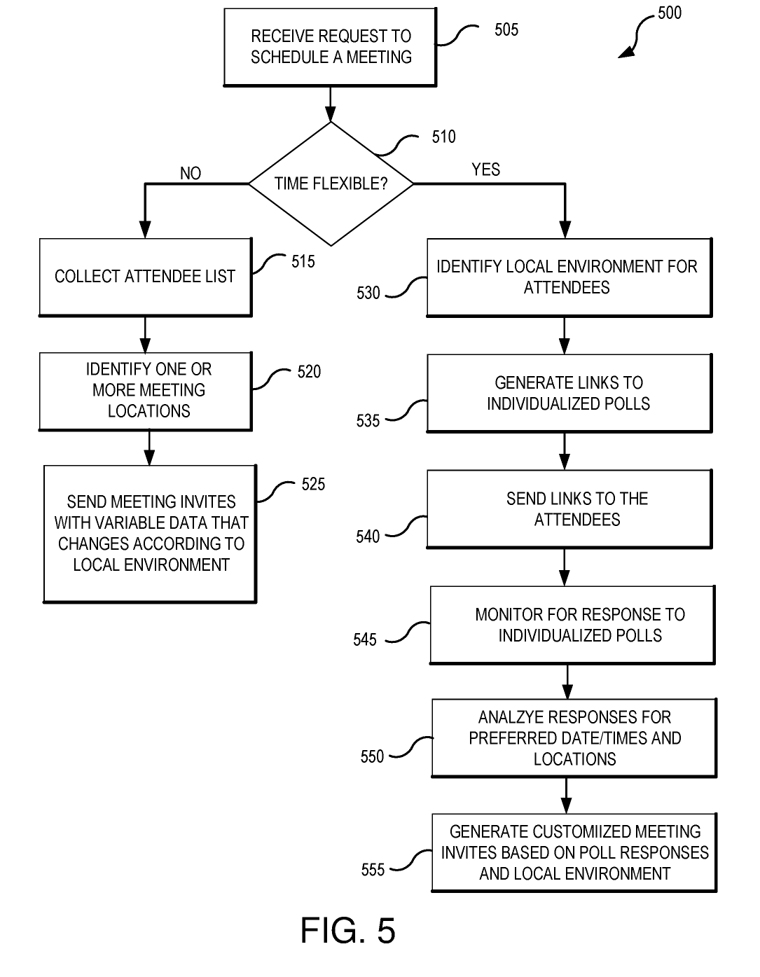

FIG. 5 illustrates an example of a set of operations 500 for allowing a meeting organizer to find and select times that may work for multiple attendees in accordance with some embodiments of the present technology. customized meeting invites according to one or more embodiments of the present technology. These operations may be performed by various systems or components such as, but not limited to, invitation tool 140, processors 210, polling module 220, identification module 225, investigation module 230, translation module 235, link generator 240, customization module 245, communication module 250, GUI generation module 255, and/or other component, computing device, or module.

As illustrated in FIG. 5, receiving operation 505 can receive a request to schedule a meeting. In some embodiments, the request may include an indication of flexibility (e.g., with regard to date, time, and/or location). For example, in some embodiments, the organizer may indicate that the meet just needs to occur within the next two days, next week, or next month. Determination operation 510 can determine whether there is any flexibility with regard to time. When determination operation 510 determines that there is no flexibility for the time/date of the meeting, determination operation 510 branches to collection operation 515 where the attendee list information (e.g., names, e-mails, local environment, etc.) are collected from the organizer or system databases. Using this information, location identification operation 520 can determine if one or more meeting locations are needed (e.g., based on employee location, number of attendees, etc.). Using this information, invitation operation 525 can generate and send meeting invites (e.g., that show individualized meeting locations, times, notes, etc.). The meeting invitations may include the same data to all attendees, but depending on when/where/how attendee accesses the invitation the attendees will see different data. As a result, the same attendee can see different data depending on local environment (e.g., location, accessing device, time of retrieval, and the like). As such, the invitation for each attendee can change according to the environment used to access the data.

When determination operation 510 determines that there is flexibility for the time/date of the meeting, determination operation 510 branches to identification operation 530 that retrieves attendees and local environment information. Using the local environmental information, generation operation 535 can generate individualized polls and links to those polls for each attendee. Transmission operation 540 then sends the links to the attendees and monitoring operation 545 monitors for attendee responses. The responses can be analyzed for preferred dates, times and/or locations for the attendees during analysis operation 550. Based on the results of that analysis and the local environment data for each attendee, generation operation 555 can generate customized meeting invites.

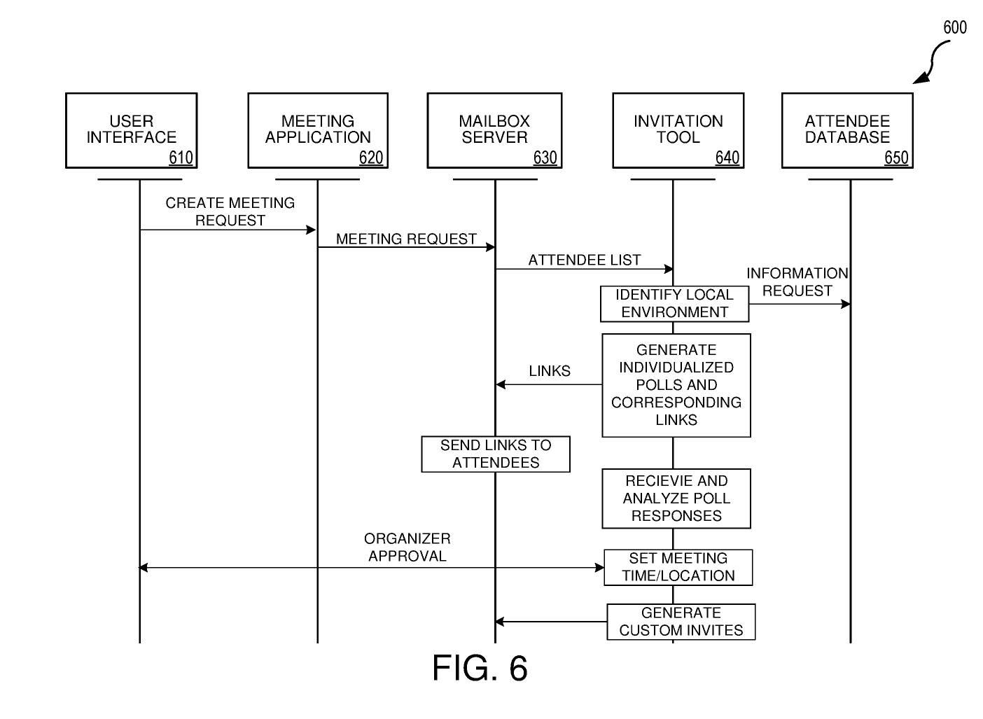

FIG. 6 is a sequence diagram 600 illustrating an example of the data flow between various components according to various embodiments of the present technology. As illustrated in FIG. 6, a user utilizes user interface 610 to create a meeting request using meeting application 620. Once created, the meeting request can be transmitted to mailbox server 630, which can send the attendee list to invention tool 640. Invitation tool 640 can then identify the local environment of each attendee. For example, invitation tool 640 may access attendee database 650 to retrieve the information.

Once the local environment is identified, invitation tool 640 can generate individualized poll and corresponding links which are conveyed to mailbox server 630 for distribution to the attendees. As the poll results are received, invitation tool 640 can analyze the responses and identify a meeting time/location. Invitation tool 640 may provide a recommendation if multiple options are available or some invitees are unavailable. Once the organizer approves, for example via user interface 610, the meeting time and locations can be set. Custom invites can be generated by invitation tool 640 and/or mailbox server 630 based on the local environment and/or user responses.

FIG. 7 illustrates computing system 710, which is representative of any system or collection of systems in which the various applications, services, scenarios, and processes disclosed herein may be implemented. For example, computing system 710 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 710 may be implemented as a single apparatus, system, or device or may be implemented in a distributed manner as multiple apparatuses, systems, or devices. Computing system 710 includes, but is not limited to, processing system 720, storage system 730, software 740, applications 750, communication interface system 760, and user interface system 770. Processing system 720 is operatively coupled with storage system 730, communication interface system 760, and an optional user interface system 770.

Processing system 720 loads and executes software 740 from storage system 730. When executed by processing system 720 for deployment of scope-based certificates in multi-tenant cloud-based content and collaboration environments, software 740 directs processing system 720 to operate as described herein for at least the various processes, operational scenarios, and sequences discussed in the foregoing implementations. Computing system 710 may optionally include additional devices, features, or functionality not discussed for purposes of brevity.

Referring still to FIG. 7, processing system 720 may comprise a micro-processor and other circuitry that retrieves and executes software 740 from storage system 730. Processing system 720 may be implemented within a single processing device, but may also be distributed across multiple processing devices or sub-systems that cooperate in executing program instructions. Examples of processing system 720 include general purpose central processing units, application specific processors, and logic devices, as well as any other type of processing device, combinations, or variations thereof.

Storage system 730 may comprise any computer readable storage media readable by processing system 720 and capable of storing software 740. Storage system 730 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 730 may also include computer readable communication media over which at least some of software 740 may be communicated internally or externally. Storage system 730 may be implemented as a single storage device, but may also be implemented across multiple storage devices or sub-systems co-located or distributed relative to each other. Storage system 730 may comprise additional elements, such as a controller, capable of communicating with processing system 720 or possibly other systems.

Software 740 may be implemented in program instructions and among other functions may, when executed by processing system 720, direct processing system 720 to operate as described with respect to the various operational scenarios, sequences, and processes illustrated herein. For example, software 740 may include program instructions for directing the system to perform the processes described above.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 740 may include additional processes, programs, or components, such as operating system software, virtual machine software, or application software. Software 740 may also comprise firmware or some other form of machine-readable processing instructions executable by processing system 720.

In general, software 740 may, when loaded into processing system 720 and executed, transform a suitable apparatus, system, or device (of which computing system 710 is representative) overall from a general-purpose computing system into a special-purpose computing system. Indeed, encoding software on storage system 730 may transform the physical structure of storage system 730. The specific transformation of the physical structure may depend on various factors in different implementations of this description. Examples of such factors may include, but are not limited to, the technology used to implement the storage media of storage system 730 and whether the computer-storage media are characterized as primary or secondary storage, as well as other factors.

For example, if the computer readable storage media are implemented as semiconductor-based memory, software 740 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 760 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 770 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 770. In some cases, the input and output devices may be combined in a single device, such as a display capable of displaying images and receiving touch gestures. The aforementioned user input and output devices are well known in the art and need not be discussed at length here. In some cases, the user interface system 770 may be omitted when the computing system 710 is implemented as one or more server computers such as, for example, blade servers, rack servers, or any other type of computing server system (or collection thereof).

User interface system 770 may also include associated user interface software executable by processing system 720 in support of the various user input and output devices discussed above. Separately or in conjunction with each other and other hardware and software elements, the user interface software and user interface devices may support a graphical user interface, a natural user interface, or any other type of user interface, in which a user interface to a productivity application may be presented.

Communication between computing system 710 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A system comprising:
one or more processors;
one or more computer readable media; and
an e-mail application stored on the one or more computer readable media, the e-mail application including program instructions which, when executed by the one or more processors, direct the one or more processors to:
receive a request to poll multiple individuals regarding availability for a meeting,
generate separate individualized links for each of the multiple individuals,
wherein each of the separate individualized links provides the poll with customized attributes based on a corresponding local environment of the multiple individuals;
transmit the separate individualized links to the multiple individuals;
receive responses to the poll through the separate individualized links; and
generate, based on the responses to the poll and the corresponding local environment of the multiple individuals, customized meeting invites to each of the multiple individuals.

2. The system of claim 1, wherein each of the separate individualized links provides multiple time and location options that are, at least in part, customized based on the corresponding local environment of an individual from the multiple individuals.

3. The system of claim 1, wherein the instructions when executed by the one or more processors generate the customized meeting invite by altering, based at least in part on the local environment, contents of a subject field, a location field, a note field, or a time field.

4. The system of claim 1, wherein the local environment includes location and preferences for working hours and language.

5. The system of claim 1, wherein the instructions when executed by the one or more processors access a database to identify the corresponding local environment of the multiple individuals.

6. A computer-readable medium having instructions stored thereon instructions that when executed by one or more processors cause a machine to:
receive a request to invite multiple individuals to a meeting;
identify characteristics of a local environment of each of the multiple individuals; and
generate, based on the characteristics of the local environment of each of the multiple individuals, a customized invite to the meeting.

7. The computer-readable medium of claim 6, further comprising instructions that when executed by the one or more processors further cause the machine, in response to the request to invite multiple people to the meeting, to:
identify the local environment of each of the multiple individuals;
access calendar information for each of the multiple individuals; and
generate a poll that with customized interfaces for each of the multiple individuals,
wherein each of the customized interfaces have multiple time and location options based on the local environment and the calendar information of each of the multiple individuals.

8. The computer-readable medium of claim 7, further comprising instructions that when executed by the one or more processors further cause the machine to receive responses from the poll and determine a meeting time.

9. The computer-readable medium of claim 8, wherein the instructions when executed by the one or more processors cause the machine to generate meeting invites to each of the multiple individuals that are customized based on the responses from the poll and the local environment of each of the multiple individuals.

10. The computer-readable medium of claim 9, wherein the instructions when executed by the one or more processors cause the machine to alter the customized invite for each of the multiple individuals, based at least in part on the local environment, contents of a subject field, a location field, a note field, or a time field.

11. The computer-readable medium of claim 7, wherein the poll includes an option for a telephone or video conference when the local environment of at least two of the multiple individuals indicate different locations.

12. The computer-readable medium of claim 11, further comprising instructions that when executed by the one or more processors further cause the machine to:
analyze responses from the poll to determine whether any individual selected a telephone conference or video conference; and
create customized invite for that individual that includes information for the telephone conference or the video conference.

13. The computer-readable medium of claim 7, wherein the instructions when executed by the one or more processors cause the machine to create individualized links for accessing the customized interfaces for each of the multiple individuals.

14. A method for creating customized meeting invites, the method comprising:
generating separate individualized links that each correspond to one of a plurality of individuals,
wherein each of the separate individualized links provides access to a poll with customized attributes based on local environments of each of the plurality of individuals;
transmitting each of the separate individualized links to each of the plurality of individuals;
receiving responses to the poll through the separate individualized links; and
generating, based on the responses to the poll, customized meeting invites to each of the plurality of individuals.

15. The method of claim 14, further comprising generating, in response to activating one of the individualized links, a graphical user interface that can be displayed on a client device, wherein the graphical user interface includes the poll with multiple time and location options based on the local environments of one of the plurality of individuals.

16. The method of claim 15, wherein the poll presented on the graphical user interface is translated into a preferred language identified by the local environment of one of the plurality of individuals.

17. The method of claim 14, wherein customized attributes include only times within working hours and text presented in a preferred language.

18. The method of claim 14, wherein generating the customized meeting invites includes altering a subject field, a location field, a notes field, or a time field.

19. The method of claim 18, wherein the customized meeting invites include only a location for a first individual from the plurality of individuals receiving the customized meeting invite.

20. The method of claim 19, wherein the meeting invite includes an option to change the location to another location shown to a second individual from the plurality of individuals.
